(19) United States
(12) Patent Application Publication
(10) Pub. No.: US 2022/0294283 A1
(43) Pub. Date: Sep. 15, 2022

(54) COIL, STATOR, MOTOR, AND MANUFACTURING METHOD OF STATOR

(71) Applicant: Komatsu Ltd., Tokyo (JP)

(72) Inventors: Hiroki Hijikata, Tokyo (JP); Natsuki Watanabe, Tokyo (JP); Teiichirou Chiba, Tokyo (JP)

(73) Assignee: Komatsu Ltd., Tokyo (JP)

(21) Appl. No.: 17/633,692

(22) PCT Filed: Aug. 24, 2020
(86) PCT No.: PCT/JP2020/031757

§ 371 Date: Feb. 8, 2022

(30) Foreign Application Priority Data
Aug. 29, 2019 (JP) 2019-157091

(51) Int. Cl. H02K 1/16; H02K 3/12; H02K 3/28

(52) U.S. Cl. CPC H02K 1/165; H02K 3/12; H02K 3/28; H02K 2213/03

(57) ABSTRACT

A coil includes a first coil piece, and a second coil piece coupled to the first coil piece. Each of the first coil piece and the second coil piece has a center portion arranged in a slot of a stator core, and an end portion protruding in an axial direction from the stator core. In the coil end portion, the end portion of the first coil piece and at least a part of the end portion of the second coil piece are arranged in the axial direction.

### FIELD

The present disclosure relates to a coil, a stator, a motor, and a manufacturing method of the stator.

### BACKGROUND

A motor includes a stator and a rotor. The stator includes a stator core and a coil. An example of stator winding wire is disclosed in Patent Literature 1.

### CITATION LIST

### Patent Literature

Patent Literature 1: Japanese Patent Application Laid-open No. 2016-073148

### SUMMARY

### Technical Problem

Full-pitch winding and short-pitch winding are known as winding methods of a coil. The full-pitch winding means a winding method in which a pole pitch of a rotor and a coil pitch of a stator are equal. The short-pitch winding means a winding method in which the coil pitch of the stator is smaller than the pole pitch of the rotor. For example, in a case where a coil of a switched reluctance motor is wound in the full-pitch winding, torque per unit volume of a stator of the full-pitch winding motor is larger than that of a short-pitch winding motor. However, a coil end of the full-pitch winding motor becomes larger than that of the short-pitch winding motor, and significant improvement in torque density of the motor cannot be expected. In addition, depending on a structure of the stator, without employment of a split stator core, it may be difficult to insert a molded coil into a slot of the stator core.

The present disclosure is to control a size of a coil end portion.

### Solution to Problem

According to an aspect of the present invention, a coil comprises: a first coil piece; and a second coil piece coupled to the first coil piece, wherein each of the first coil piece and the second coil piece includes a center portion arranged in a slot of a stator core and an end portion protruding in an axial direction from the stator core, and the end portion of the first coil piece and at least a part of the end portion of the second coil piece are arranged in an axial direction in a coil end portion.

### Advantageous Effects of Invention

According to the present disclosure, a size of a coil end portion can be controlled.

### BRIEF DESCRIPTION OF DRAWINGS

FIG. 1 is a view schematically illustrating a motor according to a first embodiment.

FIG. 2 is a perspective view illustrating a part of a stator according to the first embodiment.

FIG. 3 is a view schematically illustrating the stator and a rotor according to the first embodiment.

FIG. 4 is a view schematically illustrating teeth and coils according to the first embodiment. FIG. 5 is a perspective view illustrating a coil set according to the first embodiment.

FIG. 6 is a plan view illustrating the coil set according to the first embodiment.

FIG. 7 is a flowchart illustrating a manufacturing method of the stator according to the first embodiment.

FIG. 8 is a perspective view illustrating a first coil piece according to the first embodiment.

FIG. 9 is a perspective view illustrating a second coil piece according to the first embodiment.

FIG. 10 is a front view illustrating a U-phase coil according to the first embodiment.

FIG. 11 is a plan view illustrating the U-phase coil according to the first embodiment.

FIG. 12 is a perspective view illustrating a V-phase coil according to the first embodiment.

FIG. 13 is a plan view illustrating the V-phase coil according to the first embodiment.

FIG. 14 is a perspective view illustrating a coil set according to a second embodiment.

FIG. 15 is a plan view illustrating the coil set according to the second embodiment.

FIG. 16 is a perspective view illustrating a first coil piece according to the second embodiment.

FIG. 17 is a perspective view illustrating a second coil piece according to the second embodiment.

FIG. 18 is a perspective view illustrating a U-phase coil according to the second embodiment.

FIG. 19 is a perspective view illustrating a first coil piece according to a modification example of the second embodiment.

FIG. 20 is a perspective view illustrating a second coil piece according to the modification example of the second embodiment.

FIG. 21 is a perspective view illustrating a U-phase coil according to the modification example of the second embodiment.

FIG. 22 is a view schematically illustrating a slot according to another embodiment.

### DESCRIPTION OF EMBODIMENTS

In the following, embodiments according to the present disclosure will be described with reference to the drawings, but the present disclosure is not limited thereto. Components of the embodiments described in the following can be arbitrarily combined. Also, there is a case where a part of the components is not used.

### First Embodiment

### Motor

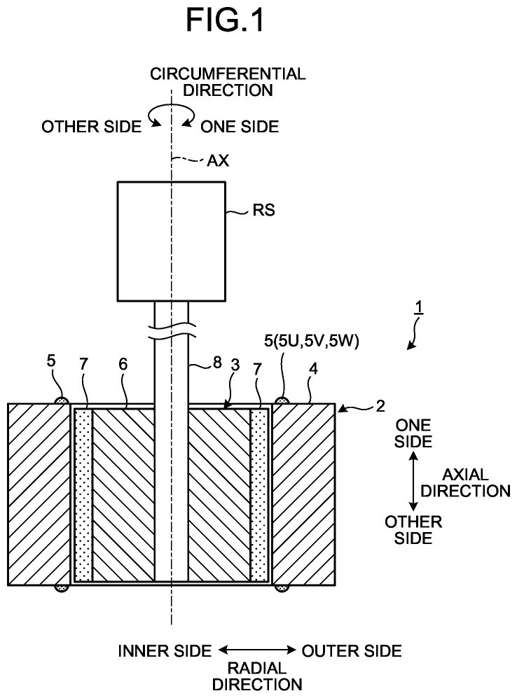

FIG. 1 is a view schematically illustrating a motor 1 according to the present embodiment. In the present embodiment, the motor 1 is a segment-type switched reluctance motor. As illustrated in FIG. 1, the motor 1 includes a stator 2 and a rotor 3.

The stator 2 is substantially cylindrical. An inner peripheral surface of the stator 2 and an outer peripheral surface of the rotor 3 face each other with a gap interposed therebetween. The rotor 3 rotates about a rotation axis AX. The rotation axis AX of the rotor 3 substantially coincides with a central axis of the stator 2.

In the present embodiment, a direction parallel to the rotation axis AX is appropriately referred to as an axial direction, a direction around the rotation axis AX is appropriately referred to as a circumferential direction, and a radiation direction of the rotation axis AX is appropriately referred to as a radial direction.

Also, a direction or a position becoming away in a prescribed direction from a center of the motor 1 in the axial direction is appropriately referred to as one side in the axial direction, and an opposite side in the axial direction of the one side in the axial direction is appropriately referred to as the other side in the axial direction. Also, a prescribed rotation direction in the circumferential direction is appropriately referred to as one side in the circumferential direction, and an opposite side in the circumferential direction of the one side in the circumferential direction is appropriately referred to as the other side in the circumferential direction. Furthermore, a direction or a position becoming away from the central axis AX in the radial direction is appropriately referred to as an outer side in the radial direction, and an opposite side in the radial direction of an inner side in the radial direction is appropriately referred to as the inner side in the radial direction.

The stator 2 includes a stator core 4, and coils 5 supported by the stator core 4. The rotor 3 is arranged on an inner side of the stator core 4. The rotor 3 includes a rotor holder 6, and rotor core pieces 7 held by the rotor holder 6. The rotor holder 6 is a non-magnetic body. The rotor core pieces 7 are magnetic bodies. The rotor core pieces 7 function as poles of the rotor 3.

The motor 1 is a three-phase motor. The coils 5 include a U-phase coil 5U, a V-phase coil 5V, and a W-phase coil 5W.

The rotor 3 is connected to an object RS via a shaft 8. Examples of the object RS include an engine mounted on a hybrid excavator that is a kind of a construction machine. The motor 1 functions as a generator driven by the engine.

### Stator

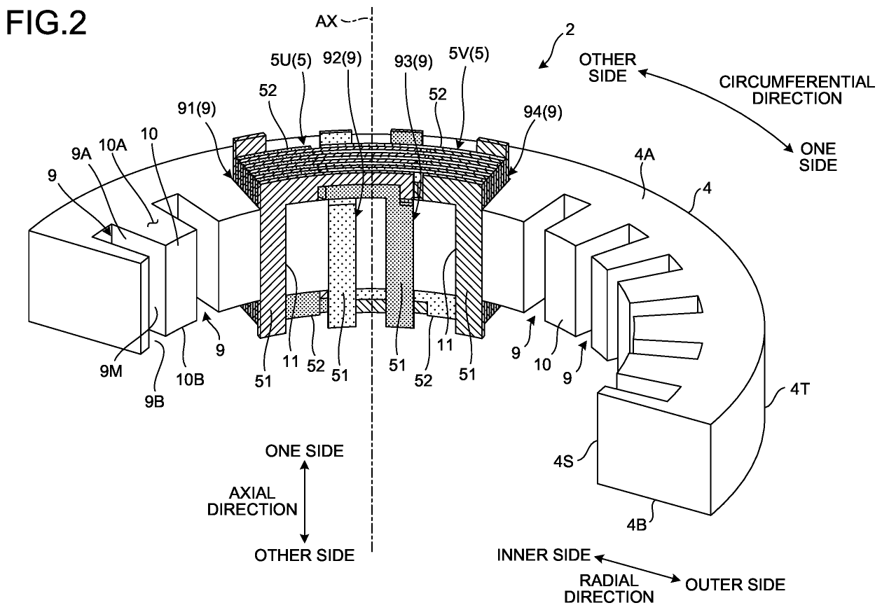

FIG. 2 is a perspective view illustrating a part of the stator 2 according to the present embodiment. As illustrated in FIG. 2, the stator 2 includes the stator core 4, and the coils 5 arranged in slots 9 of the stator core 4.

The stator core 4 has an inner peripheral surface 4S, an outer peripheral surface 4T, a first end surface 4A, and a second end surface 4B. The inner peripheral surface 4S faces the inner side in the radial direction. The outer peripheral surface 4T faces the outer side in the radial direction. The first end surface 4A faces one side in the axial direction. The second end surface 4B faces the other side in the axial direction. The first end surface 4A connects an end on the one side in the axial direction of the inner peripheral surface 4S and an end on the one side in the axial direction of the outer peripheral surface 4T. The second end surface 4B connects an end on the other side in the axial direction of the inner peripheral surface 4S and an end on the other side in the axial direction of the outer peripheral surface 4T.

The plurality of slots 9 is provided in the circumferential direction in the inner peripheral surface 4S. The slots 9 are recessed from the inner peripheral surface 4S toward the outer side in the radial direction. The slots 9 extend in the axial direction. Each of the slots 9 has an opening portion 9M provided in the inner peripheral surface 4S and facing the inner side in the radial direction, an opening portion 9A provided in the first end surface 4A and facing the one side in the axial direction, and an opening portion 9B provided in the second end surface 4B and facing the other side in the axial direction.

Also, the stator core 4 has teeth 10 arranged between the slots 9 adjacent to each other in the circumferential direction.

The teeth 10 support the coils 5. Each of the teeth 10 has an end surface 10A facing the one side in the axial direction, and an end surface 10B facing the other side in the axial direction. The first end surface 4A includes the end surface 10A. The second end surface 4B includes the end surface 10B.

The coils 5 are supported by the teeth 10. The coils 5 have openings 11. The teeth 10 are inserted into the openings 11 of the coils 5. A part of the coils 5 is arranged on an inner side of the slots 9. A part of the coils 5 protrudes in the axial direction from the stator core 4.

In the following description, a portion of each of the coils 5 which portion is arranged on the inner side of the slot 9 will be appropriately referred to as a coil center portion 51, and a portion of each of the coils 5 which portion protrudes in the axial direction from the stator core 4 will be appropriately referred to as a coil end portion 52.

Each of the coils 5 has two coil center portions 51. Each of the coils 5 has two coil end portions 52. In a case where one of the coil center portions 51 is arranged in a predetermined slot 9, the other coil center portion is arranged in a slot 9 different from the slot 9 in which the one coil center portion 51 is arranged. The coil end portions 52 include a first coil end portion 52 protruding from the first end surface 4A of the stator core 4 to the one side in the axial direction, and a second coil end portion 52 protruding from the second end surface 4B of the stator core 4 to the other side in the axial direction.

As described above, the coils 5 include the U-phase coil 5U, the V-phase coil 5V, and the W-phase coil 5W. The U-phase coil 5U and the V-phase coil 5V are illustrated in FIG. 2.

As illustrated in FIG. 2, the U-phase coil 5U and the V-phase coil 5V are overlapped. The U-phase coil 5U and the V-phase coil 5V are overlapped in such a manner that a part of the V-phase coil 5V is arranged between parts of the U-phase coil 5U and a part of the U-phase coil 5U is arranged between parts of the V-phase coil 5V, whereby a coil set 31 of the U-phase coil 5U and the V-phase coil 5V is formed.

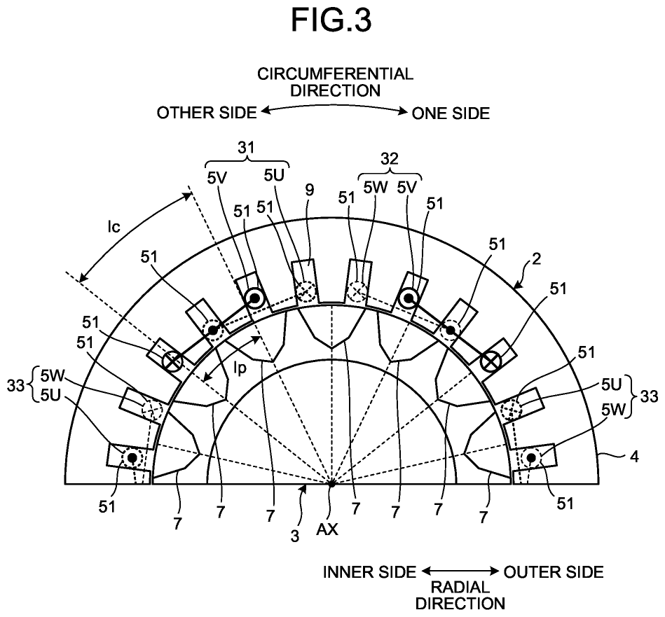

Similarly to the coil set 31, the V-phase coil 5V and the W-phase coil 5W are overlapped in such a manner that a part of the W-phase coil 5W is arranged between parts of the V-phase coil 5V and a part of the V-phase coil 5V is arranged between parts of the W-phase coil 5W, whereby a coil set 32 of the V-phase coil 5V and the W-phase coil 5W is formed. The W-phase coil 5W and the U-phase coil 5U are overlapped in such a manner that a part of the U-phase coil 5U is arranged between parts of the W-phase coil 5W and a part of the W-phase coil 5W is arranged between parts of the U-phase coil 5U, whereby a coil set 33 of the W-phase coil 5W and the U-phase coil 5U is formed. The stator core 4 supports each of the coil set 31, the coil set 32, and the coil set 33 (see FIG. 3).

The coils 5 are arranged around the teeth 10 at a pitch of two slots. That is, in a case where one coil center portion 51 of one coil 5 is arranged in a predetermined slot 9, the other coil center portion 51 is arranged in a slot 9 that is two slots away from the slot 9 in which the one coil center portion 51 is arranged in the circumferential direction.

In the example illustrated in FIG. 2, the slots 9 include a first slot 91, a second slot 92 arranged adjacent to the first slot 91 on the one side in the circumferential direction, a third slot 93 arranged adjacent to the second slot 92 on the one side in the circumferential direction, and a fourth slot 94 arranged adjacent to the third slot 93 on the one side in the circumferential direction.

The other coil center portion 51 of the U-phase coil 5U is arranged in the first slot 91. The other coil center portion 51 of the V-phase coil 5V is arranged in the second slot 92. One coil center portion 51 of the U-phase coil 5U is arranged in the third slot 93. One coil center portion 51 of the V-phase coil 5V is arranged in the fourth slot 94.

A relationship of the V-phase coil 5V and the W-phase coil 5W of the coil set 32 with the plurality of slots 9, and a relationship of the W-phase coil 5W and the U-phase coil 5U of the coil set 33 with the plurality of slots 9 are similar to a relationship of the U-phase coil 5U and the V-phase coil 5V of the coil set 31 with the plurality of slots 9.

### Relationship Between the Number of Poles and the Number of Slots

FIG. 3 is a view schematically illustrating the stator 2 and the rotor 3 according to the present embodiment. The stator 2 and the rotor 3 divided in half are illustrated in FIG. 3. Note that polarity of a winding wire illustrated in FIG. 3 is an example. The polarity of the winding wire is established in a direction illustrated in FIG. 3 or in a direction opposite to the direction illustrated in FIG. 3.

As illustrated in FIG. 3, each of the coil set 31 of the U-phase coil 5U and the V-phase coil 5V, the coil set 32 of the V-phase coil 5V and the W-phase coil 5W, and the coil set 33 of the W-phase coil 5W and the U-phase coil 5U is supported by the stator core 4. Each of the U-phase coils 5U, the V-phase coils 5V, and the W-phase coils 5W is arranged around the teeth 10 at a pitch of two slots.

The rotor 3 has the plurality of rotor core pieces 7. The plurality of rotor core pieces 7 has the same shape and the same size. The plurality of rotor core pieces 7 is arranged at equal intervals in the circumferential direction. The rotor core pieces 7 function as poles of the rotor 3. The number of poles of the rotor 3 means the number of rotor core pieces 7.

In the present embodiment, when the number of poles of the rotor 3 is P, the number of slots of the stator core 4 is S, and a natural number is N, the motor 1 satisfies conditions of the following expression (1) and expression (2).

P=7×N (1)

S=12×N (2)

That is, a 7-pole 12-slot motor, a 14-pole 24-slot motor, and a 21-pole 36-slot motor are exemplified as the motor 1 according to the present embodiment.

In the present embodiment, the number of poles P and the number of slots S are determined in such a manner that at least two coil center portions 51 of the U-phase coil 5U, the V-phase coil 5V, and the W-phase coil 5W face two rotor core pieces 7 adjacent to each other in the circumferential direction in a rotation of the rotor 3. In the example illustrated in FIG. 3, two coil center portions 51 of the V-phase coil 5V and two rotor core pieces 7 adjacent to each other in the circumferential direction face each other at the same time. When the rotor 3 rotates, a state in which two coil center portions 51 of the U-phase coil 5U and two rotor core pieces 7 adjacent to each other in the circumferential direction face each other at the same time is generated. Furthermore, when the rotor 3 rotates, a state in which two coil center portions 51 of the W-phase coil 5W and two rotor core pieces 7 adjacent to each other in the circumferential direction face each other at the same time is generated.

As described above, in the present embodiment, the number of poles P and the number of slots S are determined in such a manner that a coil pitch Ic of the U-phase coil 5U, a coil pitch Ic of the V-phase coil 5V, and a coil pitch Ic of the W-phase coil 5W are substantially equal to a pole pitch Ip of the rotor 3.

In the present embodiment, the coil pitch Ic means an angle formed by one coil center portion 51 and the other coil center portion 51 of one coil 5 with reference to the rotation axis AX. The pole pitch Ip means an angle formed by two rotor core pieces 7 adjacent to each other in the circumferential direction with reference to the rotation axis AX.

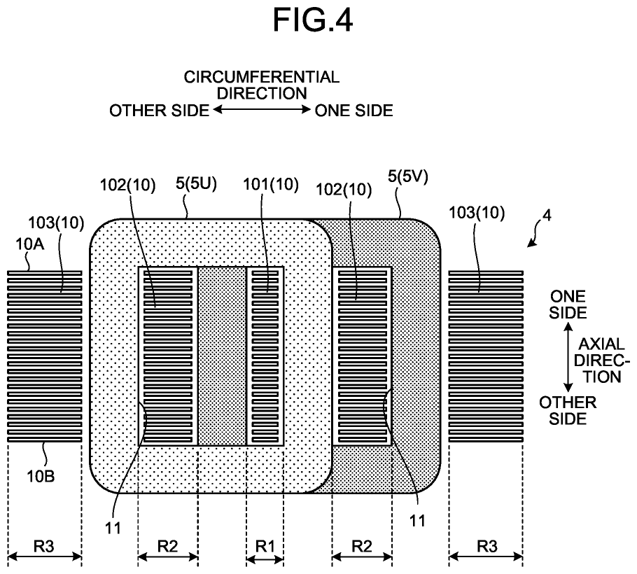

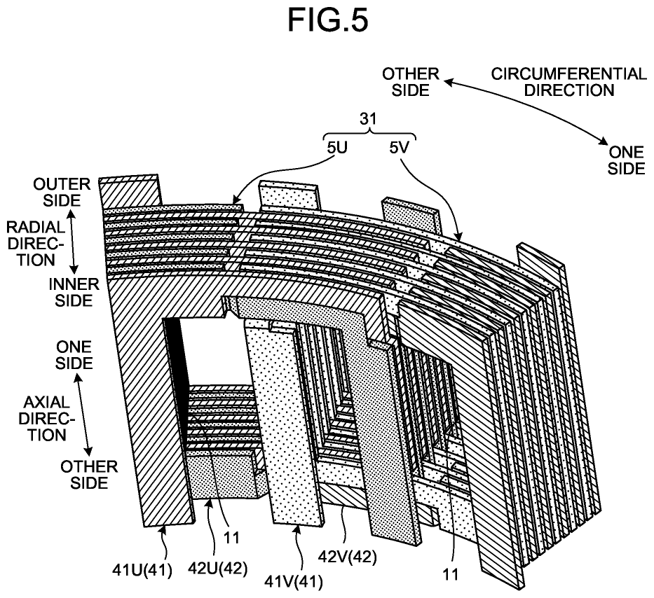

FIG. 4 is a view schematically illustrating the teeth 10 and the coils 5 according to the present embodiment. FIG. 4 corresponds to a view in which the stator core 4 is viewed from the inner side in the radial direction. As illustrated in FIG. 3 and FIG. 4, the teeth 10 include a first tooth 101 arranged in both of the opening 11 of the U-phase coil 5U and the opening 11 of the V-phase coil 5V of the coil set 31, a second tooth 102 arranged in one of the opening 11 of the U-phase coil 5U and the opening 11 of the V-phase coil 5V, and a third tooth 103 arranged in neither the opening 11 of the U-phase coil 5U nor the opening 11 of the V-phase coil 5V.

That is, the first tooth 101 is a tooth 10 arranged on an inner side of the openings 11 of the two coils 5. The second tooth 102 is a tooth 10 arranged on the inner side of the opening 11 of one coil 5. The third tooth 103 is a tooth 10 that is not arranged on the inner side of the openings 11 of the coils 5.

The first tooth 101 includes a tooth 10 arranged in both the opening 11 of the V-phase coil 5V and the opening 11 of the W-phase coil 5W of the coil set 32, and a tooth 10 arranged in both of the opening 11 of the W-phase coil 5W and the opening 11 of the U-phase coil 5U of the coil set 33.

The second tooth 102 includes a tooth 10 arranged in one of the opening 11 of the V-phase coil 5V and the opening 11 of the W-phase coil 5W of the coil set 32, and a tooth 10 arranged in one of the opening 11 of the W-phase coil 5W and the opening 11 of the U-phase coil 5U of the coil set 33.

The third tooth 103 includes a tooth 10 arranged in neither the opening 11 of the V-phase coil 5V nor the opening 11 of the W-phase coil 5W of the coil set 32, and a tooth 10 arranged in neither the opening 11 of the W-phase coil 5W nor the opening 11 of the U-phase coil 5U of the coil set 33.

In other words, the first tooth 101 is a tooth 10 in which the end surface 10A and the end surface 10B face two coils 5. The second tooth 102 is a tooth 10 in which the end surface 10A and the end surface 10B face one coil 5. The third tooth 103 is a tooth 10 in which the end surface 10A and the end surface 10B do not face the coils 5.

As illustrated in FIG. 4, among the first tooth 101, the second tooth 102, and the third tooth 103, a size R1 of the first tooth 101 is the smallest, a size R2 of the second tooth 102 is the second smallest after the first tooth 101, and a size R3 of the third tooth 103 is the largest in the circumferential direction.

### Coil

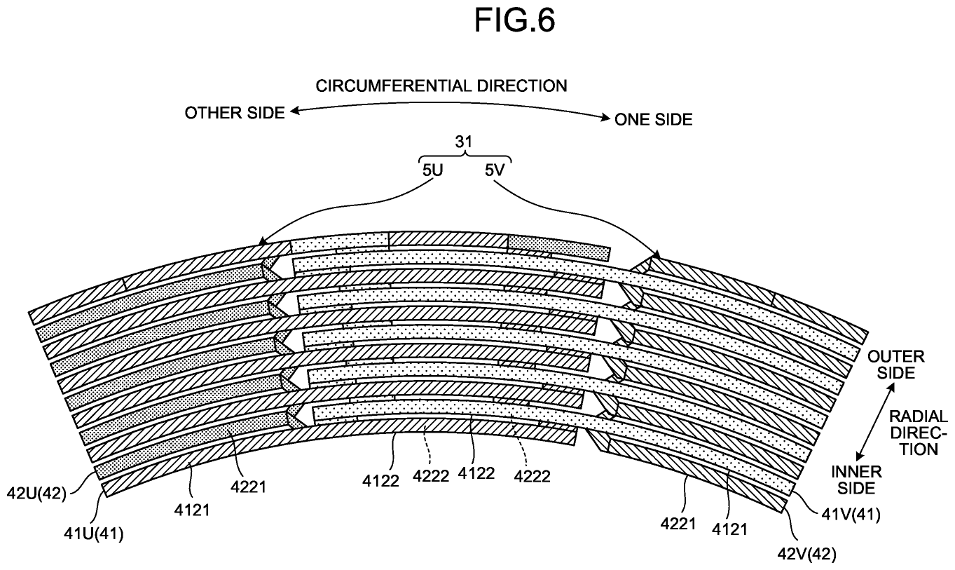

FIG. 5 is a perspective view illustrating the coil set 31 according to the present embodiment. FIG. 6 is a plan view illustrating the coil set 31 according to the present embodiment. The coil set 31 includes the U-phase coil 5U and the V-phase coil 5V.

In the present embodiment, each of the coils 5 includes a plate-shaped first coil piece 41 and a plate-shaped second coil piece 42 coupled to the first coil piece 41. Each of the U-phase coil 5U and the V-phase coil 5V includes the first coil piece 41 and the second coil piece 42. Note that similarly to the U-phase coil 5U and the V-phase coil 5V, the W-phase coil 5W includes the first coil piece 41 and the second coil piece 42 although not illustrated in FIG. 5 and FIG. 6.

The first coil pieces 41 are spiral-shaped. The second coil pieces 42 are spiral-shaped. The first coil pieces 41 and the second coil pieces 42 are coupled, whereby the spiral-shaped coils 5 are formed. The first coil pieces 41 include a first coil piece 41U included in the U-phase coil 5U, a first coil piece 41V included in the V-phase coil 5V, and a first coil piece 41W included in the W-phase coil 5W. The second coil pieces 42 include a second coil piece 42U included in the U-phase coil 5U, a second coil piece 42V included in the V-phase coil 5V, and a second coil piece 42W included in the W-phase coil 5W.

The U-phase coil 5U includes the spiral-shaped first coil piece 41U and the spiral-shaped second coil piece 42U. The V-phase coil 5V includes the spiral-shaped first coil piece 41V and the spiral-shaped second coil piece 42V. A part of the V-phase coil 5V is arranged between parts of the U-phase coil 5U. The parts of the U-phase coil 5U and the part of the V-phase coil 5V are alternately arranged in the radial direction. Since the part of the V-phase coil 5V is arranged between the parts of the U-phase coil 5U, the U-phase coil 5U and the V-phase coil 5V are overlapped, and the coil set 31 of the U-phase coil 5U and the V-phase coil 5V is formed.

Similarly, the W-phase coil 5W includes the spiral-shaped first coil piece 41W and the spiral-shaped second coil piece 42W. Since a part of the W-phase coil 5W is arranged between parts of the V-phase coil 5V, the V-phase coil 5V and the W-phase coil 5W are overlapped, and the coil set 32 of the V-phase coil 5V and the W-phase coil 5W is formed. Since a part of the U-phase coil 5U is arranged between parts of the W-phase coil 5W, the W-phase coil 5W and the U-phase coil 5U are overlapped, and the coil set 33 of the W-phase coil 5W and the U-phase coil 5U is formed. The stator core 4 supports each of the coil set 31, the coil set 32, and the coil set 33.

### Manufacturing Method

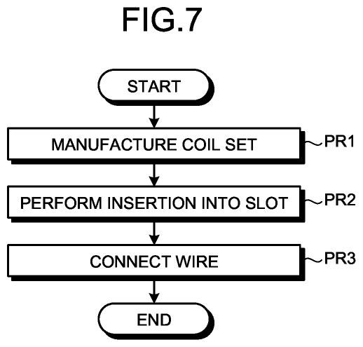

FIG. 7 is a flowchart illustrating a manufacturing method of the stator 2 according to the present embodiment. As illustrated in FIG. 7, the stator 2 is manufactured by a manufacturing method including a process PR1 of manufacturing the coil sets, a process PR2 of inserting the coil sets into the slots 9, and a process PR3 of connecting the plurality of coil sets.

In a case where the coil set 31 is manufactured, first, each of the U-phase coil 5U and the V-phase coil 5V is manufactured.

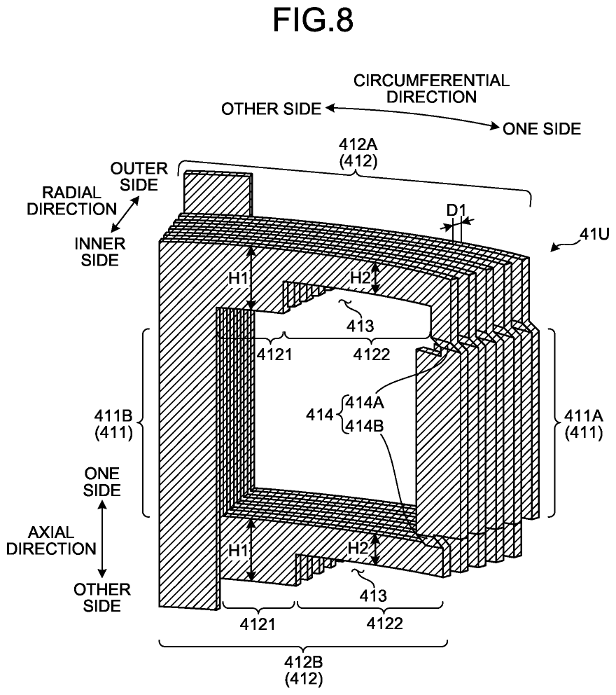

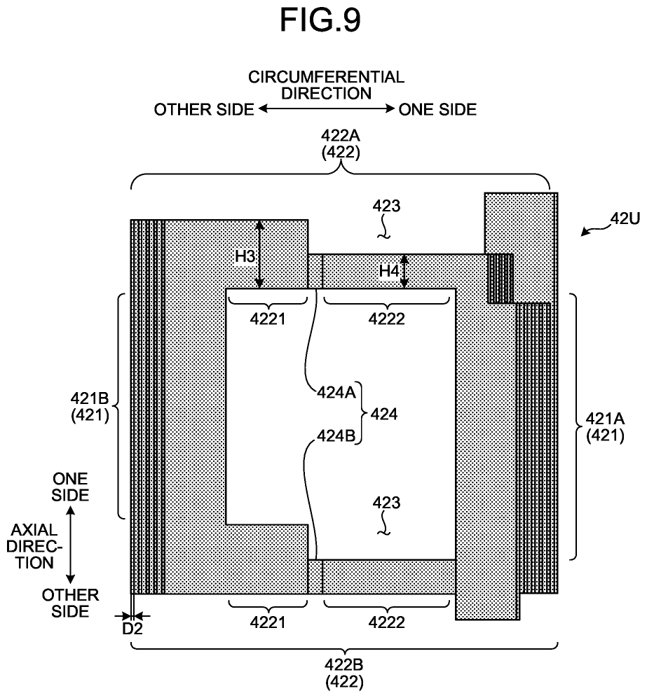

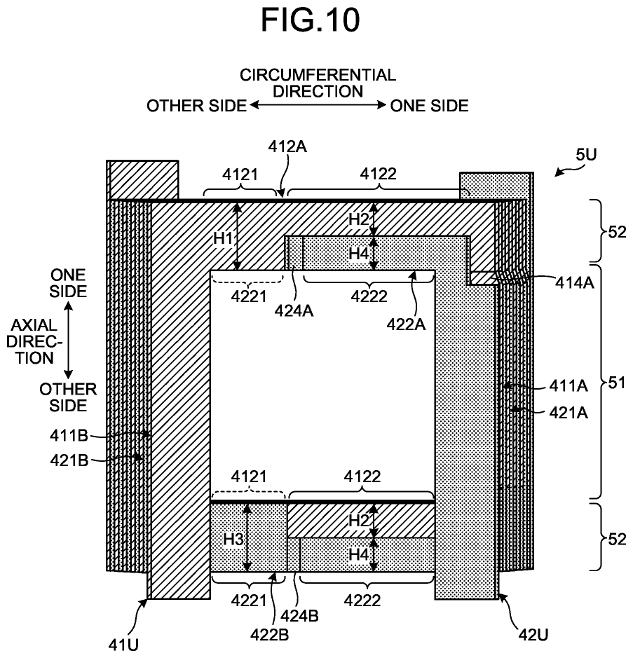

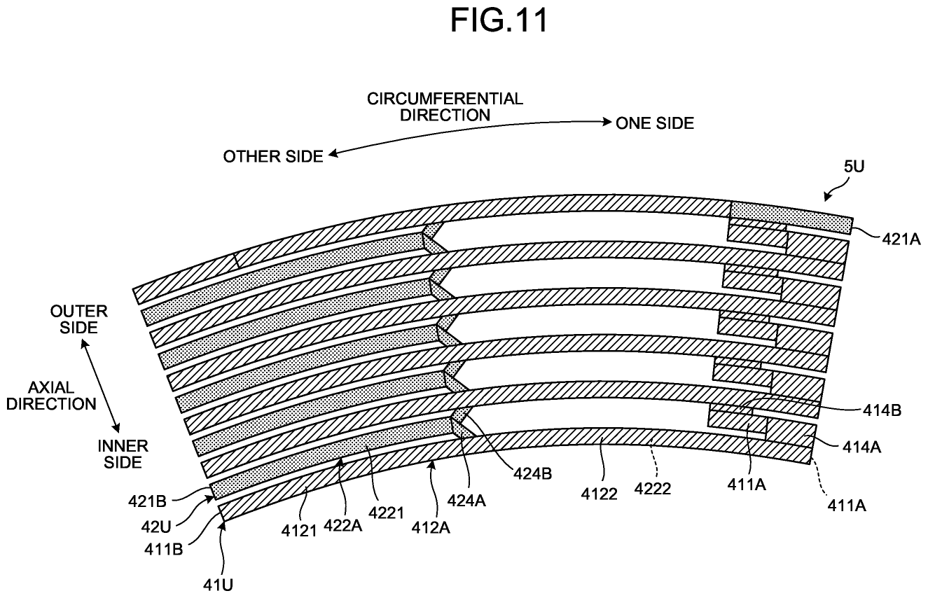

Each of FIG. 8, FIG. 9, FIG. 10, and FIG. 11 is a view for describing a manufacturing method of the U-phase coil 5U. The U-phase coil 5U is manufactured by coupling of the spiral-shaped first coil piece 41U and the spiral-shaped second coil piece 42U. The V-phase coil 5V is manufactured by coupling of the spiral-shaped first coil piece 41V and the spiral-shaped second coil piece 42V. FIG. 8 is a perspective view illustrating the first coil piece 41U according to the present embodiment. FIG. 9 is a perspective view illustrating the second coil piece 42U according to the present embodiment. FIG. 10 is a front view illustrating the U-phase coil 5U according to the present embodiment. FIG. 11 is a plan view illustrating the U-phase coil 5U according to the present embodiment.

As illustrated in FIG. 8, the first coil piece 41U is a plate-shaped member having a thickness D1. The thickness D1 means a size in the radial direction of the first coil piece 41U. The thickness D1 of the first coil piece 41U is uniform.

The first coil piece 41U has center portions 411 arranged in the slots 9 of the stator core 4 and end portions 412 protruding in the axial direction from the stator core 4. The center portions 411 extend in the axial direction. The end portions 412 extend in the circumferential direction. The center portions 411 form the coil center portion 51. Each of the end portions 412 forms the coil end portion 52.

The center portions 411 include a center portion 411A and a center portion 411B arranged at an end on the other side in the circumferential direction of the center portion 411A.

The end portions 412 include an end portion 412A that connects an end on the one side in the axial direction of the center portion 411A and an end on the one side in the axial direction of the center portion 411B, and an end portion 412B connected to an end on the other side in the axial direction of the center portion 411A.

Each of the end portions 412 has a first portion 4121, and a second portion 4122 having a width H2 smaller than a width H1 of the first portion 4121. The width H1 and the width H2 mean sizes in the axial direction of the end portions 412. The second portion 4122 is arranged on the one side in the circumferential direction of the first portion 4121. Each of the end portion 412A and the end portion 412B has the first portion 4121 and the second portion 4122.

The second portion 4122 is connected in series or in parallel to an end on the one side in the axial direction of the first portion 4121. In the example illustrated in FIG. 8, the second portion 4122 is connected in series to the one side (upper side) in the axial direction of a center portion in the axial direction of the first portion 4121. An end surface of the first portion 4121 and an end surface of the second portion 4122 on the one side in the axial direction are arranged in the same plane. A recessed portion 413 is provided in a part of a lower portion of each of the end portions 412, whereby the second portion 4122 is formed.

The first coil piece 41U has a bent portion 414 (first bent portion) bent in the radial direction between the second portion 4122 of each of the end portions 412 and the center portion 411A. The bent portions 414 include a bent portion 414A provided between an end on the one side in the axial direction of the center portion 411A and the second portion 4122 of the end portion 412A, and a bent portion 414B provided between an end on the other side in the axial direction of the center portion 411A and the second portion 4122 of the end portion 412B. The bent portions 414 are bent to the outer side in the radial direction. The center portion 411A is arranged on the outer side in the radial direction of the end portion 412A due to the bent portion 414A. The end portion 412B is arranged on the outer side in the radial direction of the center portion 411A due to the bent portion 414B. A position of the end portion 412A, a position of the center portion 411A, and positions of the end portion 412B and the center portion 411B are changed in the radial direction due to the bent portion 414A and the bent portion 414B. As a result, the first coil piece 41U has a spiral shape.

As illustrated in FIG. 9, the second coil piece 42U is a plate-shaped member having a thickness D2. The thickness D2 means a size in the radial direction of the second coil piece 42U. The thickness D2 of the second coil piece 42U is uniform. In the present embodiment, the thickness D1 of the first coil piece 41U and the thickness D2 of the second coil piece 42U are the same.

The second coil piece 42U has center portions 421 arranged in the slots 9 of the stator core 4 and end portions 422 protruding in the axial direction from the stator core 4. The center portions 421 extend in the axial direction. The end portions 422 extend in the circumferential direction. The center portions 421 form the coil center portion 51. Each of the end portions 422 forms the coil end portion 52.

The center portions 421 include a center portion 421A and a center portion 421B arranged at an end on the other side in the circumferential direction of the center portion 421A.

The end portions 422 include an end portion 422A that connects an end on the one side in the axial direction of the center portion 421A and an end on the one side in the axial direction of the center portion 421B, and an end portion 422B connected to an end on the other side in the axial direction of the center portion 421A.

Each of the end portions 422 has a third portion 4221, and a fourth portion 4222 having a width H4 smaller than a width H3 of the third portion 4221. The width H3 and the width H4 mean sizes in the axial direction of the end portions 422. The fourth portion 4222 is arranged on the one side in the circumferential direction of the third portion 4221. Each of the end portion 422A and the end portion 422B has the third portion 4221 and the fourth portion 4222.

The fourth portion 4222 is connected in series or in parallel to an end on the other side in the axial direction of the third portion 4221. In the example illustrated in FIG. 9, the fourth portion 4222 is connected in series to the other side (lower side) in the axial direction of a center portion in the axial direction of the third portion 4221. An end surface of the third portion 4221 and an end surface of the fourth portion 4222 on the other side in the axial direction are arranged in the same plane. A recessed portion 423 is provided in a part of an upper portion of each of the end portions 422, whereby the second portion 4122 is formed.

The second coil piece 42U has a bent portion 424 (second bent portion) bent in the radial direction between the third portion 4221 and the fourth portion 4222 of each of the end portions 422. The bent portions 424 include a bent portion 424A provided between the third portion 4221 and the fourth portion 4222 of the end portion 422A, and a bent portion 424B provided between the third portion 4221 and the fourth portion 4222 of the end portion 422B. The bent portions 424 are bent to the outer side in the radial direction. Due to the bent portion 424A, the third portion 4221 of the end portion 422A is arranged on the outer side in the radial direction of the fourth portion 4222 of the end portion 422A. Due to the bent portion 424B, the fourth portion 4222 of the end portion 422B is arranged on the outer side in the radial direction of the third portion 4221 of the end portion 422B. Due to the bent portion 424A and the bent portion 424B, positions of the center portion 421A and the fourth portion 4222 of the end portion 422A, positions of the third portion 4221 of the end portion 422A, the center portion 421B, and the third portion 4221 of the end portion 422B, and a position of the fourth portion 4222 of the end portion 422B are changed in the radial direction. Thus, the second coil piece 42U has a spiral shape.

In the present embodiment, the width H1 of the first portions 4121 of the first coil piece 41 and the width H3 of the third portions 4221 of the second coil piece 42 are the same. The width H2 of the second portions 4122 of the first coil piece 41 and the width H4 of the fourth portions 4222 of the second coil piece 42 are the same. The width H1 and the width H3 are larger than the width H2 and the width H4. In the present embodiment, the width H1 and the width H3 are twice as large as the width H2 and the width H4.

As illustrated in FIG. 10 and FIG. 11, the first coil piece 41 and the second coil piece 42 are coupled, whereby the U-phase coil 5U is formed. In each of the coil end portions 52, the end portion 412 of the first coil piece 41 and at least a part of the end portion 422 of the second coil piece 42 are arranged in the axial direction. In the present embodiment, the second portion 4122 of the first coil piece 41 and the fourth portion 4222 of the second coil piece 42 are arranged in the axial direction in each of the coil end portions 52. The second portion 4122 and the fourth portion 4222 overlap with each other in each of the radial direction and the circumferential direction. The fourth portion 4222 is arranged just below the second portion 4122.

As an example of the arrangement method, after a spiral-shaped winding wire is appropriately extended in the radial direction, relative rotation is performed in opposite directions from a state in which a winding start position of one on the one side in the radial direction and a winding end position of the other one on the other side in the radial direction are aligned until winding start positions or winding end positions in the radial direction of the both are aligned.

As illustrated in FIG. 11, in each of the coil end portions 52, a plurality of the second portions 4122 and the fourth portions 4222 are arranged in the radial direction in a state of being arranged in the axial direction. Also, in the coil end portion 52, the first portion 4121 and the third portion 4221 are alternately arranged in the radial direction.

In the coil center portion 51, the first coil piece 41 and the second coil piece 42 are alternately arranged in the radial direction. That is, the center portion 411A of the first coil piece 41 and the center portion 421A of the second coil piece 42 are alternately arranged in the radial direction. The center portion 411B of the first coil piece 41 and the center portion 421B of the second coil piece 42 are alternately arranged in the radial direction. Note that the center portion 421A of the second coil piece 42 is arranged just below the bent portion 414A, and the center portion 421A and a part of the end portion 412A overlap with each other in each of the radial direction and the circumferential direction. The center portion 421A is arranged just below the end portion 412A.

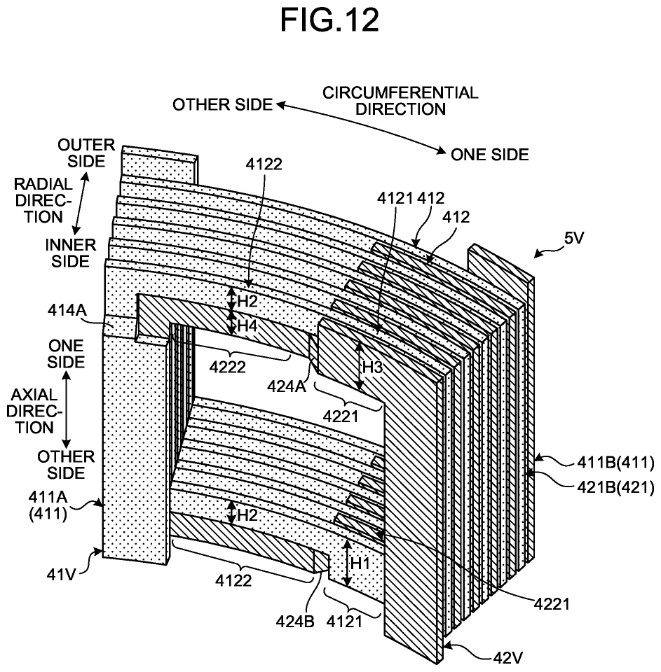

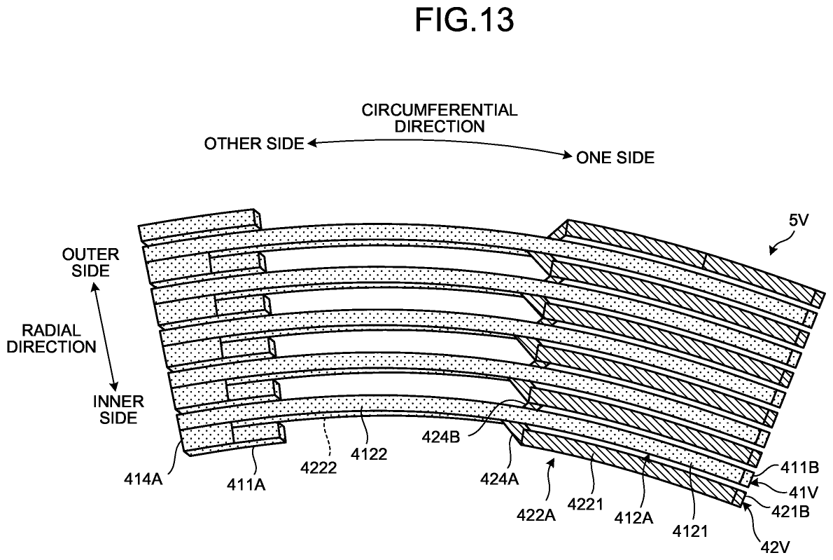

FIG. 12 is a perspective view illustrating the V-phase coil 5V according to the present embodiment. FIG. 13 is a plan view illustrating the V-phase coil 5V according to the present embodiment. Similarly to the U-phase coil 5U, the V-phase coil 5V includes the first coil piece 41V, and the second coil piece 42V coupled to the first coil piece 41V. The first coil piece 41V has center portions 411 arranged in the slots 9 of the stator core 4 and end portions 412 protruding in the axial direction from the stator core 4. The second coil piece 42V has center portions 421 arranged in the slots 9 of the stator core 4 and end portions 422 protruding in the axial direction from the stator core 4. Each of the end portions 412 of the first coil piece 41 has a first portion 4121, and a second portion 4122 having a width H2 smaller than a width H1 of the first portion 4121. Each of the end portions 422 of the second coil piece 42 has a third portion 4221, and a fourth portion 4222 having a width H4 smaller than a width H3 of the third portion 4221. The second portion 4122 of the first coil piece 41 and the fourth portion 4222 of the second coil piece 42 are arranged in the axial direction in each of the coil end portions 52. A manufacturing method of the V-phase coil 5V is similar to the manufacturing method of the U-phase coil 5U. Also, while the bent portion 414B is provided in the first coil piece 41U of the U-phase coil 5U, no bent portion 414B is provided in the first coil piece 41V of the V-phase coil 5V. Although the structure of the U-phase coil 5U and the structure of the V-phase coil 5V are different in the presence/absence of the bent portion 414B, the structure and size of the U-phase coil 5U and the structure and size of the V-phase coil 5V are substantially equal. A description of the manufacturing method of the V-phase coil 5V is omitted.

After each of the U-phase coil 5U and the V-phase coil 5V is manufactured, a part of the V-phase coil 5V is arranged between parts of the spiral-shaped U-phase coil 5U. As illustrated in FIG. 6, in each of the coil end portions 52, the second portion 4122 and the fourth portion 4222 included in the end portion of the U-phase coil 5U, and the second portion 4122 and the fourth portion 4222 included in the end portion of the V-phase coil 5V are alternately arranged in the radial direction. In the example illustrated in FIG. 6, the first portion 4121 and the third portion 4221 of the U-phase coil 5U are arranged on the other side in the circumferential direction of the second portion 4122 and the fourth portion 4222 of the U-phase coil 5U. The first portion 4121 and the third portion 4221 of the V-phase coil 5V are arranged on the one side in the circumferential direction of the second portion 4122 and the fourth portion 4222 of the V-phase coil 5V. In the present embodiment, the second portion 4122 and the fourth portion 4222 of the U-phase coil 5U and the second portion 4122 and the fourth portion 4222 of the V-phase coil 5V overlap with each other in the circumferential direction. The first portion 4121 and the third portion 4221 of the U-phase coil 5U do not overlap with the V-phase coil 5V, and the first portion 4121 and the fourth portion 4222 of the V-phase coil 5V do not overlap with the U-phase coil 5U.

As an example of the arrangement method, a spiral-shaped winding wires are appropriately extended in the radial direction, and then combined while being guided by a jig or the like, which simulates a stator shape, in such a manner that coil end portions of different phases are alternately overlapped in the radial direction. Then, the extended winding wires are compressed in the radial direction, and a shape is fixed by mechanical or thermal treatment.

The U-phase coil 5U and the V-phase coil 5V are overlapped in such a manner that the second portion 4122 and the fourth portion 4222 included in the end portion of the U-phase coil 5U and the second portion 4122 and the fourth portion 4222 included in the end portion of the V-phase coil 5V are alternately arranged in the radial direction in each of the coil end portions 52, whereby the coil set 31 of the U-phase coil 5U and the V-phase coil 5V is manufactured. Similarly, the V-phase coil 5V and the W-phase coil 5W are overlapped in such a manner that the second portion 4122 and the fourth portion 4222 included in the end portion of the V-phase coil 5V and a second portion 4122 and a fourth portion 4222 included in an end portion of the W-phase coil 5W are alternately arranged in the radial direction in each of the coil end portions 52, whereby the coil set 32 of the V-phase coil 5V and the W-phase coil 5W is manufactured. The W-phase coil 5W and the U-phase coil 5U are overlapped in such a manner that the second portion 4122 and the fourth portion 4222 included in the end portion of the W-phase coil 5W and the second portion 4122 and the fourth portion 4222 included in the end portion of the U-phase coil 5U are alternately arranged in the radial direction in each of the coil end portions 52, whereby the coil set 33 of the W-phase coil 5W and the U-phase coil 5U is manufactured (Process PR1).

Each of the coil end portions 52 of the coil set 31, the coil set 32, and the coil set 33 has the second portion 4122 and the fourth portion 4222. After the coil set 31, the coil set 32, and the coil set 33 are manufactured, the coil set 31, the coil set 32, and the coil set 33 are respectively inserted into the slots 9 from the inner side in the radial direction. Each of the U-phase coil 5U, the V-phase coil 5V, and the W-phase coil 5W is attached to the stator core 4 in such a manner that the second portions 4122 of the first coil piece 41 and the fourth portions 4222 of the second coil piece 42 protrude in the axial direction from the stator core 4.

As illustrated in FIG. 3, the coil set 33 is arranged on the one side in the circumferential direction of the coil set 32, and the coil set 32 is arranged on the one side in the circumferential direction of the coil set 31. One coil center portion 51 is arranged in each of the plurality of slots 9 (Process PR2).

After the coil set 31, the coil set 32, and the coil set 33 are respectively inserted into the slots 9, the plurality of coils 5 is connected by a wire connection member (Process PR3).

In the middle of the coil manufacturing process, appropriate insulation processing between the coils and the stator, or between the coils in the same phase or in different phases is performed.

From the above, the stator 2 is manufactured.

### Effect

As described above, according to the present embodiment, each of the coils 5 includes the first coil piece 41, and the second coil piece 42 coupled to the first coil piece 41. Each of the end portions 412 of the first coil piece 41 has the first portion 4121, and the second portion 4122 having the width H2 smaller than the width H1 of the first portion 4121. Each of the end portions 422 of the second coil piece 42 has the third portion 4221, and the fourth portion 4222 having the width H4 smaller than the width H3 of the third portion 4221. The second portion 4122 of the first coil piece 41 and the fourth portion 4222 of the second coil piece 42 are arranged in the axial direction in each of the coil end portions 52. Thus, a size of the coil end portions 52 can be controlled.

For example, in a case where sizes in the axial direction of the end portions of the coils 5 are uniform, when the plurality of coils 5 overlaps in the coil end portions 52, the coil end portions 52 become large. The coil end portions 52 do not contribute to generation of torque by the motor 1. Thus, when the coil end portions 52 become large, the motor 1 increases in size although the torque generated by the motor 1 does not increase. As a result, torque density of the motor 1 decreases. The torque density means a value acquired by division of the torque, which can be generated by the motor 1, by mass or volume of the motor 1. The torque density is preferably large.

According to the present embodiment, the second portions 4122 and the fourth portions 4222 of the two coils 5 are arranged in the axial direction in each of the coil end portions 52. Also, in the coil end portion 52, the first portion 4121 and the third portion 4221 are not arranged in the axial direction of the other coils 5. Thus, the coil end portion 52 is prevented from becoming large. Thus, an increase in size of the motor 1 is controlled.

In the present embodiment, the second portion 4122 is connected in series or in parallel to the end on the one side in the axial direction of the first portion 4121, and the fourth portion 4222 is connected in series or in parallel to the end on the other side in the axial direction of the third portion 4221. Also, in the present embodiment, the end surface of the first portion 4121 and the end surface of the second portion 4122 on the one side in the axial direction are arranged in the same plane, and the end surface of the third portion 4221 and the end surface of the fourth portion 4222 on the other side in the axial direction are arranged in the same plane. Thus, the second portion 4122 is arranged in the recessed portion 423 of the second coil piece 42, and the fourth portion 4222 is arranged in the recessed portion 413 of the first coil piece 41. Since the second portion 4122 is arranged in the recessed portion 423 of the second coil piece 42 and the fourth portion 4222 is arranged in the recessed portion 413 of the first coil piece 41, there is no portion protruding in the axial direction in the coil end portion 52. Thus, the increase in size of the motor 1 is controlled.

The first coil piece 41 has the bent portions 414. Due to the bent portions 414, the center portion 421A of the first coil piece 41 overlaps with at least a part of the end portions 412 of the first coil piece 41 in each of the radial direction and the circumferential direction. Thus, in a case where the first coil piece 41 and the second coil piece 42 are alternately arranged in the radial direction in the coil center portion 51, a space factor is improved.

The second coil piece 42 has the bent portions 424. Due to the bent portions 424, the second portions 4122 of the first coil piece 41 and the fourth portions 4222 of the second coil piece 42 overlap with each other in each of the radial direction and the circumferential direction. Thus, the size of the coil end portions 52 is controlled.

The width H1 and the width H3 are the same, the width H2 and the width H4 are the same, and the width H1 and the width H3 are larger than the width H2 and the width H4. In the present embodiment, the width H1 and the width H3 are twice as large as the width H2 and the width H4. Thus, in a state in which the second portions 4122 are arranged in the recessed portions 423 of the second coil piece 42 and the fourth portions 4222 are arranged in the recessed portions 413 of the first coil piece 41, generation of portions protruding in the axial direction in the coil end portions 52 is controlled.

The thickness D1 of the first coil piece 41 is uniform, and the thickness D2 of the second coil piece 42 is uniform. Thus, the first coil piece 41 and the second coil piece 42 are efficiently manufactured.

In the present embodiment, the motor 1 satisfies the conditions of the expression (1) and expression (2). In the 7-pole 12-slot motor 1, the coils 5 can be arranged at a pitch of two slots. Thus, the size of the coil end portions 52 can be controlled.

For example, in a case where coils are arranged at a pitch of three slots, three coils overlap in a coil end portion. As a result, the coil end portion becomes large. According to the present embodiment, the number of overlapping coils 5 in each of the coil end portions 52 is two. Thus, the coil end portion 52 is prevented from becoming large. Thus, an increase in size of the motor 1 is controlled.

Also, for example, the motor 1 having the coils 5 arranged at a pitch of two slots can generate larger torque than a motor having coils arranged at a pitch of one slot. That is, the motor 1 can generate sufficient torque since the coils are arranged at a pitch of two slots. Thus, a decrease in the torque density of the motor 1 is controlled.

Also, a coil pitch Ic of the two-slot pitch is smaller than a coil pitch of the three-slot pitch. Thus, according to the present embodiment, phase resistance of the coils 5 is reduced as compared with the three-slot pitch. Thus, deterioration in performance of the motor 1 is controlled.

Also, in the present embodiment, since seven poles and 12 slots are employed, coil sets in each of which two coils 5 are combined can be molded and then the coil sets can be inserted into the slots 9 from the inner side in the radial direction. According to the present embodiment, for example, it is possible to insert the molded coils 5 (coil set) wound in a bobbin shape into the slots 9 of the stator core 4 without employing a split stator core. Thus, the motor 1 can be easily manufactured.

In the present embodiment, the teeth 10 include the first tooth 101 in which the end surface 10A and the end surface 10B face two coils 5, the second tooth 102 in which the end surface 10A and the end surface 10B face one coil 5, and the third tooth 103 in which the end surface 10A and the end surface 10B face no coil 5. The first tooth 101 is arranged on the inner side of the openings 11 of the two coils 5. The second tooth 102 is arranged on the inner side of the opening 11 of the one coil 5. The third tooth 103 is not arranged on the inner side of the openings 11 of the coils 5. In the circumferential direction, the size R1 of the first tooth 101 is the smallest, the size R2 of the second tooth 102 is the second smallest after the first tooth 101, and the size R3 of the third tooth 103 is the largest. The inventor of the present invention has found that the torque generated by the motor 1 is improved when the first tooth 101, the second tooth 102, and the third tooth 103 satisfy the condition of [R1<R2<R3]. It is considered that this is because a leakage flux is reduced and a magnetic flux can appropriately flow when the stator 2 is designed to satisfy the condition of [R1<R2<R3]. When the condition of [R1<R2<R3] is satisfied, the motor 1 can generate large torque.

The coil pitch Ic and the pole pitch Ip are determined in such a manner that the two coil center portions 51 of each of the coils 5 and the two adjacent rotor core pieces 7 face each other in the rotation of the rotor 3, whereby the motor 1 can generate torque appropriately.

### Second Embodiment

The second embodiment will be described. In the following description, the same sign is assigned to a component identical or equivalent to that of the above-described embodiment, and a description thereof is simplified or omitted.

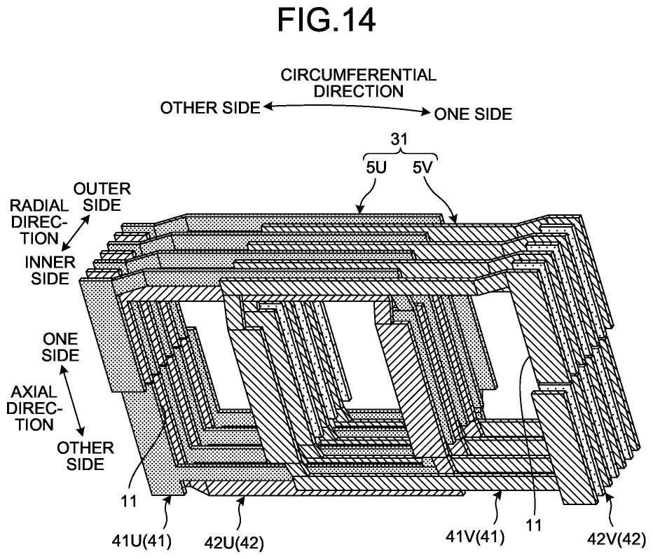

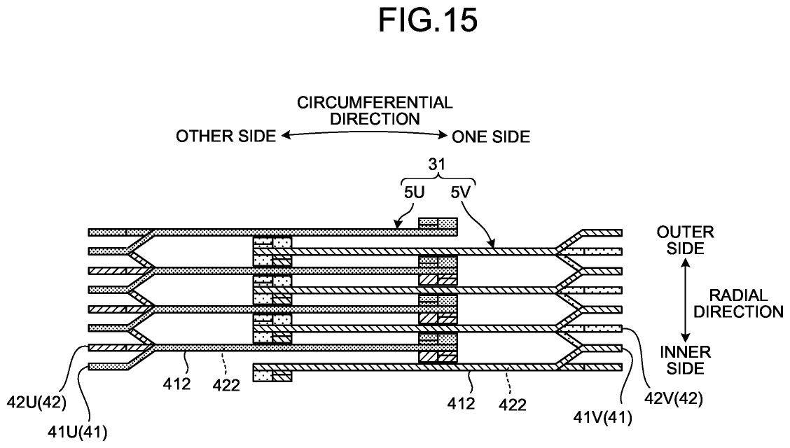

FIG. 14 is a perspective view illustrating a coil set 31 according to the present embodiment. FIG. 15 is a plan view illustrating the coil set 31 according to the present embodiment. The coil set 31 includes a U-phase coil 5U and a V-phase coil 5V.

Similarly to the above-described embodiment, each coil 5 includes a plate-shaped first coil piece 41, and a plate-shaped second coil piece 42 coupled to the first coil piece 41. Each of the U-phase coil 5U and the V-phase coil 5V includes the first coil piece 41 and the second coil piece 42. Note that similarly to the U-phase coil 5U and the V-phase coil 5V, a W-phase coil 5W includes the first coil piece 41 and the second coil piece 42 although not illustrated in FIG. 14 and FIG. 15.

The first coil pieces 41 are spiral-shaped. The second coil pieces 42 are spiral-shaped. The first coil pieces 41 and the second coil pieces 42 are coupled, whereby the spiral-shaped coils 5 are formed. The first coil pieces 41 include a first coil piece 41U included in the U-phase coil 5U, a first coil piece 41V included in the V-phase coil 5V, and a first coil piece 41W included in the W-phase coil 5W. The second coil pieces 42 include a second coil piece 42U included in the U-phase coil 5U, a second coil piece 42V included in the V-phase coil 5V, and a second coil piece 42W included in the W-phase coil 5W.

The U-phase coil 5U includes the spiral-shaped first coil piece 41U and the spiral-shaped second coil piece 42U. The V-phase coil 5V includes the spiral-shaped first coil piece 41V and the spiral-shaped second coil piece 42V. A part of the V-phase coil 5V is arranged between parts of the U-phase coil 5U. The parts of the U-phase coil 5U and the part of the V-phase coil 5V are alternately arranged in a radial direction. Since the part of the V-phase coil 5V is arranged between the parts of the U-phase coil 5U, the U-phase coil 5U and the V-phase coil 5V are coupled, and the coil set 31 of the U-phase coil 5U and the V-phase coil 5V is formed.

Similarly, the W-phase coil 5W includes the spiral-shaped first coil piece 41W and the spiral-shaped second coil piece 42W. Since a part of the W-phase coil 5W is arranged between parts of the V-phase coil 5V, the V-phase coil 5V and the W-phase coil 5W are coupled, and a coil set 32 of the V-phase coil 5V and the W-phase coil 5W is formed. Since a part of the U-phase coil 5U is arranged between parts of the W-phase coil 5W, the W-phase coil 5W and the U-phase coil 5U are coupled, and a coil set 33 of the W-phase coil 5W and the U-phase coil 5U is formed. A stator core 4 supports each of the coil set 31, the coil set 32, and the coil set 33.

Next, a manufacturing method of the coil set 31 will be described. In a case where the coil set 31 is manufactured, first, each of the U-phase coil 5U and the V-phase coil 5V is manufactured.

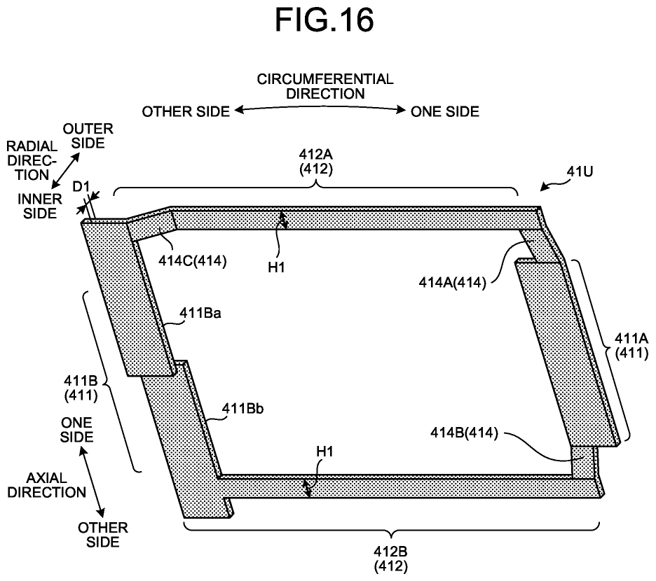

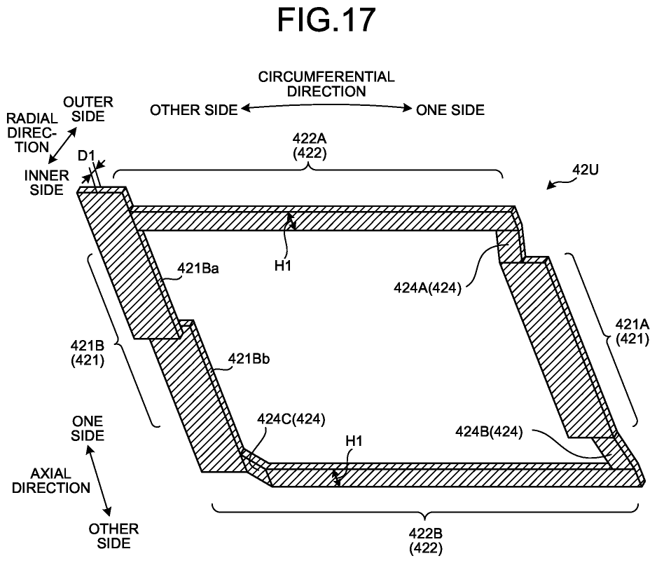

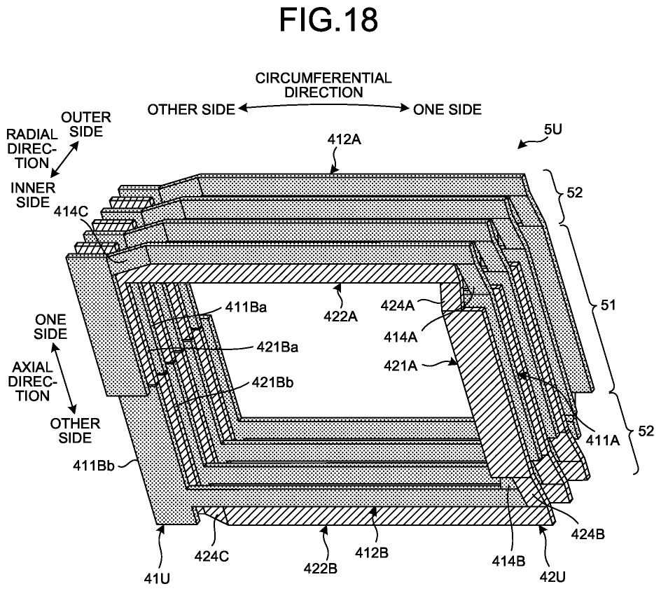

Each of FIG. 16, FIG. 17, and FIG. 18 is a view for describing a manufacturing method of the U-phase coil 5U. The U-phase coil 5U is manufactured by coupling of the spiral-shaped first coil piece 41U and the spiral-shaped second coil piece 42U. The V-phase coil 5V is manufactured by coupling of the spiral-shaped first coil piece 41V and the spiral-shaped second coil piece 42V. FIG. 16 is a perspective view illustrating the first coil piece 41U according to the present embodiment. FIG. 17 is a perspective view illustrating the second coil piece 42U according to the present embodiment. FIG. 18 is a perspective view illustrating the U-phase coil 5U according to the present embodiment.

As illustrated in FIG. 16, the first coil piece 41U is a plate-shaped member having a thickness D1. The thickness D1 means a size in the radial direction of the first coil piece 41U. The thickness D1 of the first coil piece 41U is uniform.

The first coil piece 41U has center portions 411 arranged in slots 9 of the stator core 4 and end portions 412 protruding in an axial direction from the stator core 4. The center portions 411 extend in the axial direction. The end portions 412 extend in a circumferential direction.

The center portions 411 form a coil center portion 51. The end portions 412 form coil end portions 52.

The center portions 411 include a center portion 411A and a center portion 411B arranged at an end on the other side in the circumferential direction of the center portion 411A.

The end portions 412 include an end portion 412A connecting an end on one side in the axial direction of the center portion 411A and an end on the one side in the axial direction of the center portion 411B, and an end portion 412B connecting an end on the other side in the axial direction of the center portion 411A and an end on the other side in the axial direction of the center portion 411B.

The center portion 411B is separated at an intermediate portion in the axial direction. The center portion 411B includes a center upper portion 411Ba connected to the end portion 412A, and a center lower portion 411Bb connected to the end portion 412B.

A width H1 of the end portions 412 is uniform. The width H1 means a size in the axial direction of the end portions 412.

The first coil piece 41U has bent portions 414. The bent portions 414 includes a bent portion 414A provided between the end on the one side in the axial direction of the center portion 411A and the end portion 412A, a bent portion 414B provided between the end on the other side in the axial direction of the center portion 411A and the end portion 412B, and a bent portion 414C provided between an end on the other side in the circumferential direction of the end portion 412A and the center upper portion 411Ba.

The center portion 411A is arranged on an outer side in the radial direction of the end portion 412A due to the bent portion 414A. The end portion 412B is arranged on an inner side in the radial direction of the center portion 411A due to the bent portion 414B. Due to the bent portion 414C, the center upper portion 411Ba is arranged on the inner side in the radial direction of the end portion 412A, the center lower portion 411Bb, and the end portion 412B.

As illustrated in FIG. 17, the second coil piece 42U has a shape equal to that of the first coil piece 41U. The second coil piece 42U is acquired by inversion of the first coil piece 41U in the radial direction. The second coil piece 42U is a plate-shaped member having the thickness D1.

The second coil piece 42U has center portions 421 arranged in the slots 9 of the stator core 4 and end portions 422 protruding in the axial direction from the stator core 4. The center portions 421 extend in the axial direction. The end portions 422 extend in the circumferential direction. The center portions 421 form the coil center portion 51. Each of the end portions 422 forms the coil end portion 52.

The center portions 421 include a center portion 421A and a center portion 421B arranged at an end on the other side in the circumferential direction of the center portion 421A.

The end portions 422 include an end portion 422A connecting an end on the one side in the axial direction of the center portion 421A and an end on the one side in the axial direction of the center portion 421B, and an end portion 422B connecting an end on the other side in the axial direction of the center portion 421A and an end on the other side in the axial direction of the center portion 421B.

The center portion 421B is separated at an intermediate portion in the axial direction. The center portion 421B includes a center upper portion 421Ba connected to the end portion 422A, and a center lower portion 421Bb connected to the end portion 422B.

A width H1 of the end portions 422 is uniform. The width H1 means a size in the axial direction of the end portions 422.

The second coil piece 42U has bent portions 424. The bent portions 424 include a bent portion 424A provided between the end on the one side in the axial direction of the center portion 421A and the end portion 422A, a bent portion 424B provided between the end on the other side in the axial direction of the center portion 421A and the end portion 422B, and a bent portion 424C provided between an end on the other side in the circumferential direction of the end portion 422B and the center lower portion 421Bb.

The center portion 421A is arranged on the inner side in the radial direction of the end portion 422A due to the bent portion 424A. The end portion 422B is arranged on the outer side in the radial direction of the center portion 421A due to the bent portion 424B. Due to the bent portion 424C, the center lower portion 421Bb is arranged on the outer side in the radial direction of the end portion 422B, the center upper portion 421Ba, and the end portion 422A.

As illustrated in FIG. 18, the first coil piece 41U and the second coil piece 42U are coupled, whereby the U-phase coil 5U is formed. In each of the coil end portions 52, the end portion 412 of the first coil piece 41U and at least a part of the end portion 422 of the second coil piece 42U are arranged in the axial direction. In the coil end portion 52, the end portion 412 of the first coil piece 41U and the end portion 422 of the second coil piece 42U overlap with each other in each of the radial direction and the circumferential direction. The end portion 422 of the second coil piece 41U is arranged immediately below the end portion 412 of the first coil piece 42U.

In the coil end portion 52, a plurality of the end portions 412 and the end portions 422 are arranged in the radial direction in a state of being arranged in the axial direction.

In the coil center portion 51, the first coil piece 41 and the second coil piece 42 are alternately arranged in the radial direction.

The center portion 411A of the first coil piece 41 and the center portion 421A of the second coil piece 42 are alternately arranged in the radial direction.

The center upper portion 411Ba of the first coil piece 41 and the center upper portion 421Ba of the second coil piece 42 are alternately arranged in the radial direction. The center lower portion 411Bb of the first coil piece 41 and the center lower portion 421Bb of the second coil piece 42 are alternately arranged in the radial direction.

In the present embodiment, an end surface of the center lower portion 411Bb of the first coil piece 41 and an end surface of the center upper portion 421Ba of the second coil piece 42 are connected, and an end surface of the center upper portion 411Ba of the first coil piece 41 and an end surface of the center lower portion 421Bb of the second coil piece 42 are connected. Thus, the U-phase coil 5U is wound in a spiral shape.

A manufacturing method of the V-phase coil 5V, the V-phase coil 5V including the first coil piece 41V and the second coil piece 42V coupled to the first coil piece 41V similarly to the U-phase coil 5U, is similar to the manufacturing method of the U-phase coil 5U. A description of the manufacturing method of the V-phase coil 5V is omitted.

After each of the U-phase coil 5U and the V-phase coil 5V is manufactured, a part of the V-phase coil 5V is arranged between parts of the spiral-shaped U-phase coil 5U. As illustrated in FIG. 15, in each of the coil end portions 52, the end portion 412 and the end portion 422 included in the end portion of the U-phase coil 5U and the end portion 412 and the end portion 422 included the end portion of the V-phase coil 5V are alternately arranged in the radial direction. The U-phase coil 5U and the V-phase coil 5V are coupled, whereby the coil set 31 of the U-phase coil 5U and the V-phase coil 5V is manufactured. Similarly, the coil set 32 of the V-phase coil 5V and the W-phase coil 5W, and the coil set 33 of the W-phase coil 5W and the U-phase coil 5U are manufactured.

From the above, the stator 2 is manufactured.

As described above, also in the present embodiment, the end portion 412 of the first coil piece 41 and the end portion 422 of the second coil piece 42 are arranged in the axial direction. Thus, a size of the coil end portions 52 can be controlled.

### Modification Example

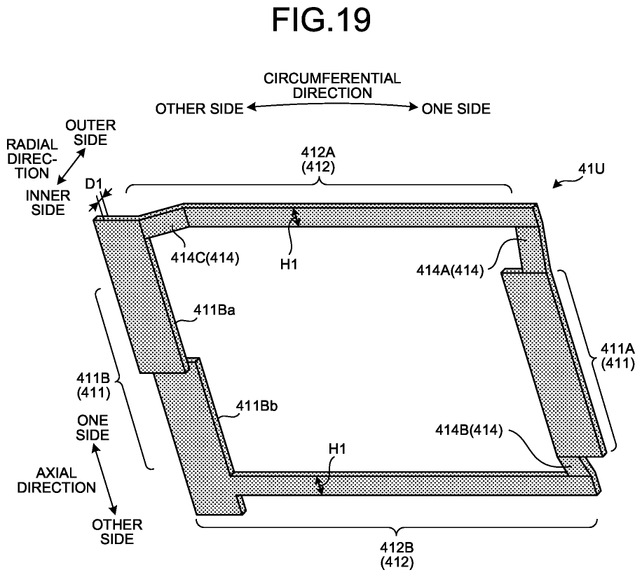

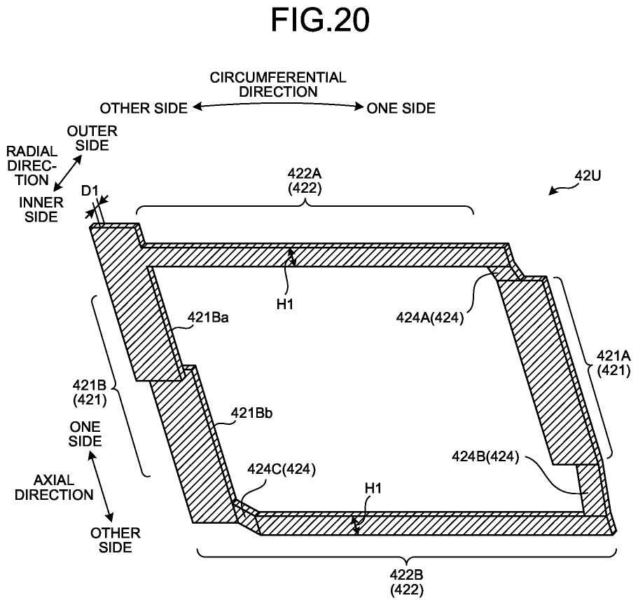

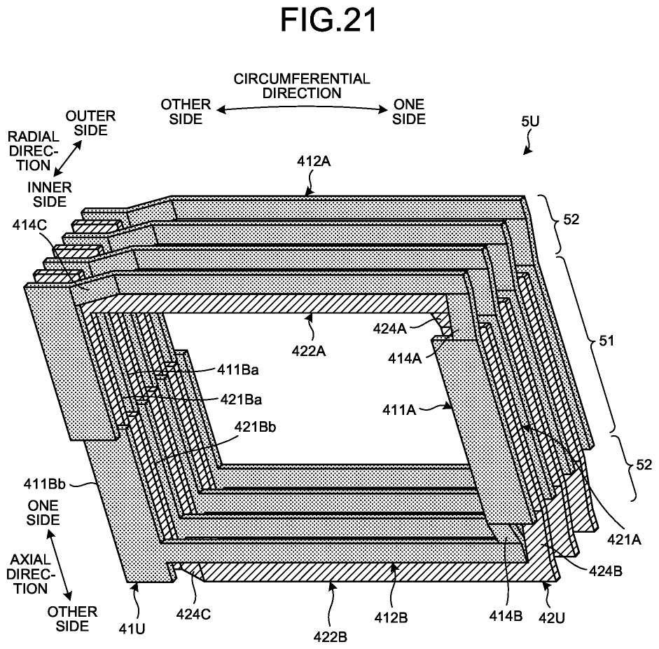

Next, a modification example of the manufacturing method of the coil set 31 according to the present embodiment will be described. Each of FIG. 19, FIG. 20, and FIG. 21 is a view for describing a manufacturing method of a U-phase coil 5U. FIG. 19 is a perspective view illustrating a first coil piece 41U according to the modification example of the present embodiment. FIG. 20 is a perspective view illustrating a second coil piece 42U according to the modification example of the present embodiment. FIG. 21 is a perspective view illustrating a U-phase coil 5U according to the modification example of the present embodiment.

As illustrated in FIG. 19, the first coil piece 41U includes center portions 411 and end portions 412. The center portions 411 include a center portion 411A and a center portion 411B arranged at an end on the other side in a circumferential direction of the center portion 411A. The end portions 412 include an end portion 412A connecting an end on one side in an axial direction of the center portion 411A and an end on the one side in the axial direction of the center portion 411B, and an end portion 412B connecting an end on the other side in the axial direction of the center portion 411A and an end on the other side in the axial direction of the center portion 411B.

The center portion 411B is separated at an intermediate portion in the axial direction. The center portion 411B includes a center upper portion 411Ba connected to the end portion 412A, and a center lower portion 411Bb connected to the end portion 412B.

Bent portions 414 of the first coil piece 41U includes a bent portion 414A provided between the end on the one side in the axial direction of the center portion 411A and the end portion 412A, a bent portion 414B provided between the end on the other side in the axial direction of the center portion 411A and the end portion 412B, and a bent portion 414C provided between an end on the other side in the circumferential direction of the end portion 412A and the center upper portion 411Ba.

The center portion 411A is arranged on an inner side in a radial direction of the end portion 412A due to the bent portion 414A. The end portion 412B is arranged on an outer side in the radial direction of the center portion 411A due to the bent portion 414B. Due to the bent portion 414C, the center upper portion 411Ba is arranged on the inner side in the radial direction of the end portion 412A, the center lower portion 411Bb, and the end portion 412B.

As illustrated in FIG. 21, the second coil piece 42U has a shape equal to that of the first coil piece 41U. The second coil piece 42U is acquired by inversion of the first coil piece 41U in the radial direction.

The second coil piece 42U includes center portions 421 and end portions 422. The center portions 421 include a center portion 421A and a center portion 421B arranged at an end on the other side in the circumferential direction of the center portion 421A. The end portions 422 include an end portion 422A connecting an end on the one side in the axial direction of the center portion 421A and an end on the one side in the axial direction of the center portion 421B, and an end portion 422B connecting an end on the other side in the axial direction of the center portion 421A and an end on the other side in the axial direction of the center portion 421B.

The center portion 421B is separated at an intermediate portion in the axial direction. The center portion 421B includes a center upper portion 421Ba connected to the end portion 422A, and a center lower portion 421Bb connected to the end portion 422B.

Bent portions 424 of the second coil piece 42U includes a bent portion 424A provided between the end on the one side in the axial direction of the center portion 421A and the end portion 422A, a bent portion 424B provided between the end on the other side in the axial direction of the center portion 421A and the end portion 422B, and a bent portion 424C provided between an end on the other side in the circumferential direction of the end portion 422B and the center lower portion 421Bb.

The center portion 421A is arranged on the outer side in the radial direction of the end portion 422A due to the bent portion 424A. The end portion 422B is arranged on the inner side in the radial direction of the center portion 421A due to the bent portion 424B. Due to the bent portion 424C, the center lower portion 421Bb is arranged on the outer side in the radial direction of the end portion 422B, the center upper portion 421Ba, and the end portion 422A.

As illustrated in FIG. 21, the first coil piece 41U and the second coil piece 42U are coupled, whereby the U-phase coil 5U is formed. In a coil end portion 52, the end portion 412 of the first coil piece 41U and at least a part of the end portion 422 of the second coil piece 42U are arranged in the axial direction. In the coil end portion 52, the end portion 412 of the first coil piece 41U and the end portion 422 of the second coil piece 42U overlap with each other in each of the radial direction and the circumferential direction. The end portion 422 of the second coil piece 41U is arranged immediately below the end portion 412 of the first coil piece 42U.

In the coil end portion 52, a plurality of the end portions 412 and the end portions 422 are arranged in the radial direction in a state of being arranged in the axial direction.

In the coil center portion 51, the first coil piece 41 and the second coil piece 42 are alternately arranged in the radial direction.

The center portion 411A of the first coil piece 41 and the center portion 421A of the second coil piece 42 are alternately arranged in the radial direction.

The center upper portion 411Ba of the first coil piece 41 and the center upper portion 421Ba of the second coil piece 42 are alternately arranged in the radial direction. The center lower portion 411Bb of the first coil piece 41 and the center lower portion 421Bb of the second coil piece 42 are alternately arranged in the radial direction.

In the present embodiment, an end surface of the center lower portion 411Bb of the first coil piece 41 and an end surface of the center upper portion 421Ba of the second coil piece 42 are connected, and an end surface of the center upper portion 411Ba of the first coil piece 41 and an end surface of the center lower portion 421Bb of the second coil piece 42 are connected. Thus, the U-phase coil 5U is wound in a spiral shape.

A manufacturing method of a V-phase coil 5V, the V-phase coil 5V including a first coil piece 41V and a second coil piece 42V coupled to the first coil piece 41V similarly to the U-phase coil 5U, is similar to the manufacturing method of the U-phase coil 5U. A description of the manufacturing method of the V-phase coil 5V is omitted.

### Other Embodiments

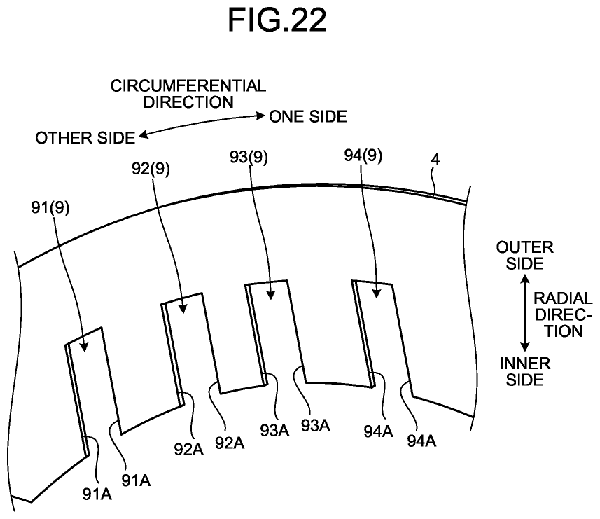

FIG. 22 is a view schematically illustrating slots 9 according to the present embodiment. As illustrated in FIG. 22, in a cross section orthogonal to a rotation axis AX, an inner surface 91A of a first slot 91, an inner surface 92A of a second slot 92, an inner surface 93A of a third slot 93, and an inner surface 94A of a fourth slot 94 have nearly parallel shapes. The inner surfaces of the slots 9 mean surfaces extending in each of an axial direction and a radial direction and facing inner peripheral surfaces of openings 11 of coils 5.

As described above, for example, in a case where a coil set 31 is inserted into the slots 9, the other coil center portion 51 of a U-phase coil 5U is arranged in the first slot 91, the other coil center portion 51 of a V-phase coil 5V is arranged in the second slot 92, one coil center portion 51 of the U-phase coil 5U is arranged in the third slot 93, and one coil center portion 51 of the V-phase coil 5V is arranged in the fourth slot. Since the inner surface 91A of the first slot 91, the inner surface 92A of the second slot 92, the inner surface 93A of the third slot 93, and the inner surface 94A of the fourth slot 94 have the nearly parallel shapes, the coil set 31 is smoothly inserted into the slots 9.

Note that it is assumed in the above-described embodiment that the motor 1 is a segment-type switched reluctance motor. A motor 1 may be a switched reluctance motor provided with pole teeth, a synchronous reluctance motor, a flux switching motor, a permanent magnet motor, an induction motor, an axial gap motor, or a linear actuator.

It is assumed in the above-described embodiment that the motor 1 is a three-phase motor. A motor 1 may be a four-phase motor. In this case, when the number of poles of the rotor is P, the number of slots of the stator core is S, and a natural number is N,

P=5×N, and

S=8×N,
are satisfied.

### Reference Signs List

1 MOTOR
2 STATOR
3 ROTOR
4 STATOR CORE
4A FIRST END SURFACE
4B SECOND END SURFACE
4S INNER PERIPHERAL SURFACE
4T OUTER PERIPHERAL SURFACE
5 COIL
5U U-PHASE COIL
5V V-PHASE COIL
5W W-PHASE COIL
6 ROTOR HOLDER
7 ROTOR CORE PIECE
8 SHAFT
9 SLOT
9A OPENING PORTION
9B OPENING PORTION
9M OPENING PORTION
10 TOOTH
10A END SURFACE
10B END SURFACE
11 OPENING
31 COIL SET
32 COIL SET
33 COIL SET
41 FIRST COIL PIECE
41U FIRST COIL PIECE
41V FIRST COIL PIECE
41W FIRST COIL PIECE
42 SECOND COIL PIECE
42U SECOND COIL PIECE
42V SECOND COIL PIECE
42W SECOND COIL PIECE
51 COIL CENTER PORTION
52 COIL END PORTION
91 FIRST SLOT
91A INNER SURFACE
92 SECOND SLOT
92A INNER SURFACE
93 THIRD SLOT
93A INNER SURFACE
94 FOURTH SLOT
94A INNER SURFACE
101 FIRST TOOTH
102 SECOND TOOTH
103 THIRD TOOTH
411 CENTER PORTION
411A CENTER PORTION
411B CENTER PORTION
412 END PORTION
412A END PORTION
412B END PORTION
413 RECESSED PORTION
414 BENT PORTION (FIRST BENT PORTION)
414A BENT PORTION
414B BENT PORTION
421 CENTER PORTION
421A CENTER PORTION
421B CENTER PORTION
422 END PORTION
422A END PORTION
422B END PORTION
423 RECESSED PORTION
424 BENT PORTION (SECOND BENT PORTION)
424A BENT PORTION
424B BENT PORTION
4121 FIRST PORTION
4122 SECOND PORTION
4221 THIRD PORTION
4222 FOURTH PORTION
AX ROTATION AXIS
D1 THICKNESS
D2 THICKNESS
Ic COIL PITCH
Ip POLE PITCH
R1 SIZE
R2 SIZE
R3 SIZE
RS OBJECT

1. A coil comprising:
a first coil piece; and
a second coil piece coupled to the first coil piece, wherein
each of the first coil piece and the second coil piece includes a center portion arranged in a slot of a stator core and an end portion protruding in an axial direction from the stator core, and
the end portion of the first coil piece and at least a part of the end portion of the second coil piece are arranged in an axial direction in a coil end portion.

2. The coil according to claim 1, wherein
the end portion of the first coil piece has a first portion, and a second portion having a width smaller than a width of the first portion,
the end portion of the second coil piece has a third portion, and a fourth portion having a width smaller than a width of the third portion, and
the second portion of the first coil piece and the fourth portion of the second coil piece are arranged in the axial direction in the coil end portion.

3. The coil according to claim 2, wherein
the second portion is connected in series or in parallel to an end on one side in the axial direction of the first portion, and
the fourth portion is connected in series or in parallel to an end on other side in the axial direction of the third portion.

4. The coil according to claim 3, wherein
an end surface of the first portion and an end surface of the second portion on the one side in the axial direction are arranged in a same plane, and
an end surface of the third portion and an end surface of the fourth portion on the other side in the axial direction are arranged in a same plane.

5. The coil according to claim 2, wherein
the first coil piece includes a first bent portion bent in a radial direction between the second portion and the center portion of the first coil piece, and
the first coil piece and the second coil piece are alternately arranged in the radial direction in a coil center portion.

6. The coil according to claim 2, wherein
the second coil piece includes a second bent portion bent in a radial direction between the third portion and the fourth portion, and
the first portion and the third portion are alternately arranged in the radial direction in the coil end portion.

7. The coil according to claim 2, wherein
the width of the first portion and the width of the third portion are same,
the width of the second portion and the width of the fourth portion are same, and
the width of the first portion is larger than the width of the second portion.

8. A stator comprising:
a stator core; and
the coil according to claim 1.

9. The stator according to claim 8, wherein
the coil includes a first-phase coil, a second-phase coil, and a third-phase coil,
a coil set of the first-phase coil and the second-phase coil is formed by an arrangement of a part of the second-phase coil between parts of the first-phase coil and an arrangement of a part of the first-phase coil between parts of the second-phase coil,
a coil set of the second-phase coil and the third-phase coil is formed by an arrangement of a part of the third-phase coil between parts of the second-phase coil and an arrangement of a part of the second-phase coil between parts of the third-phase coil,
a coil set of the third-phase coil and the first-phase coil is formed by an arrangement of a part of the first-phase coil between parts of the third-phase coil and an arrangement of a part of the third-phase coil between parts of the first-phase coil, and
in a coil end portion, end portions of the first-phase coil and end portions of the second-phase coil are alternately arranged in a radial direction, end portions of the second-phase coil and end portions of the third-phase coil are alternately arranged in the radial direction, and end portions of the third-phase coil and end portions of the first-phase coil are alternately arranged in the radial direction.

10. The stator according to claim 8, wherein
the stator core includes a tooth arranged between the slots adjacent to each other, and
the coil is arranged around the tooth at a pitch of two slots.

11. A motor comprising:
the stator according to claim 8; and
a rotor arranged on an inner side of the stator core, wherein
when the number of poles of the rotor is P, the number of slots of the stator core is S, and a natural number is N,
a condition of
P=7×N, and
S=12×N
is satisfied.

12. A manufacturing method of a stator, comprising:
forming a coil by connecting a first coil piece and a second coil piece in such a manner that an end portion of the first coil piece and at least a part of an end portion of the second coil piece are arranged in an axial direction; and
mounting the coil on a stator core in such a manner that the end portions protrude in the axial direction from the stator core.
